(19) United States
(12) Patent Application Publication
(10) Pub. No.: US 2023/0120366 A1
(43) Pub. Date: Apr. 20, 2023

(54) ORGANIZATION SYSTEM WITH CONFIGURABLE BINS

(71) Applicant: DV International Inc., St. Paul, MN (US)

(72) Inventor: Hallie L. Stevens, Minneapolis, MN (US)

(21) Appl. No.: 17/966,258

(22) Filed: Oct. 14, 2022

Related U.S. Application Data
(60) Provisional application No. 63/255,835, filed on Oct. 14, 2021.

(51) Int. Cl. B65D 25/06; B65D 21/02

(52) U.S. Cl. CPC B65D 25/06; B65D 21/0212

(57) ABSTRACT

A receptacle having a first receptacle dimension and a second receptacle dimension, wherein the first receptacle dimension and the second receptacle dimension are a discrete number of bin units in length, with one or more bins configured to fit within the receptacle, each bin having a first bin dimension and a second bin dimension, wherein the first bin dimension and the second bin dimension of each bin are a discrete number of bin units in length is disclosed.

This application claims the benefit of U.S. Provisional Application Ser. No. 63/255,835, filed Oct. 14, 2021, which application is hereby incorporated by reference in its entirety.

### FIELD

Embodiments herein relate to organization systems. More specifically, embodiments herein relates organization systems with configurable bins.

### BACKGROUND

Organization systems are used in numerous applications including home, office, and industrial settings. Organization systems can take numerous forms including free-standing organization systems, closet organization systems and drawer organization systems. Organization systems incorporate features such as bins, slots, compartments, shelves to keep items organized and easily accessible.

### SUMMARY

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

In an embodiment, a organization system is included having a receptacle, one or more bins configured to fit within the receptacle, each bin having a first bin dimension and a second bin dimension, each bin is included having a bottom bin surface, a bin wall surrounding the perimeter of the bottom bin surface, an upper projection protruding from the bin wall, and a lower projection protruding from the bin wall beneath the upper projection, wherein a first bin can be stacked on top of a second bin in a first orientation if the first bin dimension of the first bin is equal to the first bin dimension or the second bin dimension of the second bin such that the lower projection of the first bin engages with the upper projection of the second bin and the first bin can slide along the upper projection of the second bin on a first set of parallel sides, and wherein the first bin can be stacked on top of the second bin in a second orientation if the second bin dimension of the first bin is equal to the first bin dimension or the second bin dimension of the second bin such that the lower projection of the first bin engages with the upper projection of the second bin and the first bin can slide along the upper projection of the second bin on a second set of parallel sides.

In an embodiment, the receptacle having a first receptacle dimension and a second receptacle dimension, wherein the first receptacle dimension and the second receptacle dimension are a discrete number of bin units in length.

In an embodiment, the first bin dimension and the second bin dimension of each bin are a discrete number of bin units in length.

In an embodiment, the combined number of bin units for all of the one or more bins is equal to the number of bin units of the receptacle.

In an embodiment, wherein all of the one or more bins can be placed in the receptacle such that the one or more bins span, substantially, the entire area of the bottom receptacle surface.

In an embodiment, the one or more bins can be placed in the receptacle in multiple configurations.

In an embodiment, the combined length of one or more of the bins is equal to the number of bin units of the first receptacle dimension and/or the second receptacle dimension.

In an embodiment, the upper projection spans the entire perimeter of the bin wall.

In an embodiment, the lower projection spans the entire perimeter of the bin wall.

In an embodiment, the upper projection and the lower projection both protrude between 0.5 mm and 2 mm from the bin wall.

In an embodiment, the lower projection is be disposed greater than or equal to 50% of the way down between the top of the bin and the bottom bin surface.

In an embodiment, the lower projection protrudes no further from the bin wall than the upper projection.

In an embodiment, wherein each of the bins includes a means for preventing slipping with respect to the bottom receptacle surface.

In an embodiment, wherein each of the one or more bins includes a plurality of feet to engage with a plurality of opening in the bottom receptacle surface.

In an embodiment, the receptacle and each of the bins have anti-microbial properties.

In an embodiment, the cross-sectional area of each of the one or more bins tapers beneath the lower projection.

In an embodiment, a bin system is included having A first bin having a first bin dimension and a second bin dimension, the first bin is included having a first bottom surface, a first wall surrounding the perimeter of the first bottom bin surface, the first wall is included having an first upper projection protruding from the first bin wall, and a first lower projection protruding from the first bin wall beneath the first upper projection, A second bin having a first bin dimension and a second bin dimension, the second bin is included having a second bottom surface, a second wall surrounding the perimeter of the second bottom bin surface, the second wall is included having a second upper rim protruding outward from of the second wall, and a second lower rim protruding outward from the second wall beneath the second upper rim, wherein the first bin can be stacked on top of the second bin in a first orientation if the first bin dimension of the first bin is equal to the first bin dimension or the second bin dimension of the second bin such that the first lower projection engages with the second upper projection and the first bin can slide along the second upper projection on a first set of parallel sides, and wherein the first bin can be stacked on top of the second bin in a second orientation if the second bin dimension of the first bin is equal to the first bin dimension or the second bin dimension of the second bin such that the first lower projection engages with the second upper projection and the first bin can slide along the second upper projection on a second set of parallel sides.

In an embodiment, further can include: A third bin having a first bin dimension and a second bin dimension, the first bin can include: a third bottom surface, a third wall surrounding the perimeter of the third bottom bin surface, the third wall can include: and third upper projection protruding from the first bin wall, and a third lower projection protruding from the first bin wall beneath the first upper projection, wherein the third bin can be stacked on top of the first bin or the second bin in a first orientation if the first bin dimension of the third bin is equal to the first bin dimension or the second bin dimension of the first bin or the second bin such that the third lower projection engages with the first upper projection or the second upper projection and the third bin can slide along the first upper projection or the second upper projection on a first set of parallel sides, and wherein the third bin can be stacked on top of the first bin or the second bin in a second orientation if the second bin dimension of the third bin is equal to the first bin dimension or the second bin dimension of the first bin or the second bin such that the third lower projection engages with the first upper projection or the second upper projection and the third bin can slide along the first upper projection or the second upper projection on a second set of parallel sides.

In an embodiment, a organization system is included having a receptacle having a first receptacle dimension and a second receptacle dimension, wherein the first receptacle dimension and the second receptacle dimension are a discrete number of bin units in length one or more bins configured to fit within the receptacle, each bin having a first bin dimension and a second bin dimension, wherein the first bin dimension and the second bin dimension of each bin are a discrete number of bin units in length, each bin is included having a bottom bin surface, a bin wall surrounding the perimeter of the bottom bin surface, an upper projection protruding from the bin wall, and a lower projection protruding from the bin wall beneath the upper projection, wherein a first bin can be stacked on top of a second bin in a first orientation if the first bin dimension of the first bin is equal to the first bin dimension or the second bin dimension of the second bin such that the lower projection of the first bin engages with the upper projection of the second bin and the first bin can slide along the upper projection of the second bin on a first set of parallel sides, and wherein the first bin can be stacked on top of the second bin in a second orientation if the second bin dimension of the first bin is equal to the first bin dimension or the second bin dimension of the second bin such that the lower projection of the first bin engages with the upper projection of the second bin and the first bin can slide along the upper projection of the second bin on a second set of parallel sides. wherein the combined number of bin units for all of the one or more bins is equal to the number of bin units of the receptacle such that the one or more bins can be placed in the receptacle such that the one or more bins span, substantially, the entire area of the bottom receptacle surface.

In an embodiment, the one or more bins can be placed in the receptacle in multiple configurations.

### BRIEF DESCRIPTION OF THE FIGURES

Aspects may be more completely understood in connection with the following figures (FIGS.), in which:

FIG. 1 is a perspective view of an organization system in accordance with various embodiments herein.

FIG. 2 is a side view of a bin in accordance with various embodiments herein.

FIG. 3 is a detailed view of the bin of FIG. 2 in accordance with various embodiments herein.

FIG. 4 is a detailed view of the bin of FIG. 2 in accordance with various embodiments herein.

FIG. 5 is a top view of a bin in accordance with various embodiments herein.

FIG. 6 is a cross sectional view of a bin in accordance with various embodiments herein.

FIG. 7 is a bottom view of a bin in accordance with various embodiments herein.

FIG. 8 is a top view of a set of bins in accordance with various embodiments herein.

FIG. 9 is a top view of a set of bins in accordance with various embodiments herein.

FIG. 10 is a top view of a set of bins in accordance with various embodiments herein.

FIG. 11 is a top view of a set of bins in accordance with various embodiments herein.

FIG. 12 is a cross-sectional view of a set of bins in accordance with various embodiments herein.

FIG. 13 is a side view of a receptacle in accordance with various embodiments herein.

FIG. 14 is a top view of a receptacle in accordance with various embodiments herein.

FIG. 14 is a top view of a receptacle in accordance with various embodiments herein.

FIG. 15 is a bottom view of a receptacle in accordance with various embodiments herein.

FIG. 16 is a side view of a lidded bin in accordance with various embodiments herein.

FIG. 17 is a top view of a receptacle in accordance with various embodiments herein.

FIG. 18 is a top view of a bin in accordance with various embodiments herein.

FIG. 19 is a top view of an organization system in accordance with various embodiments herein.

FIG. 20 is a perspective view of an organization system in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The embodiments described herein are not intended to be exhaustive or to limit the invention to the precise forms disclosed in the following detailed description. Rather, the embodiments are chosen and described so that others skilled in the art can appreciate and understand the principles and practices.

A system for organizing items in a customizable fashion is described herein. The organization system uses a receptacle and one or more free-standing bins to keep items organized and accessible. The organization system can be placed in a drawer or sit on any free surface. The one or more bins can be arranged and configured in a variety of different ways to build a unique organizational system. The bins can be placed in the receptacle, stacked on top of one another, or used externally from the organization system. The organization system can have a means for preventing the bins form slipping within the receptacle. For instance, each of the one or more bins can have a plurality of feet to engage with a peg-board style receptacle.

Each of the bins can have a plurality of projections such that one of the bins can be stacked on top of and slid with respect to another. The dimensions of each of the bins of the organization system are chosen such that the bins can be stacked and slid on top of one another in multiple orientations and configurations. The convenient stack-and-slide feature provides easy access to contents stored in the organization system.

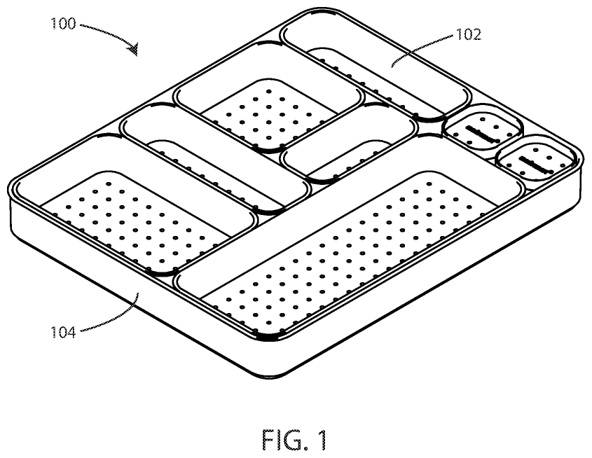

Referring now to FIG. 1, a perspective view of an organization system is shown in accordance with various embodiments herein. The organization system 100 can include a receptacle 104 and one or more bins 102. In some embodiments, the number of bins 102 can be greater than or equal to 1 bin, 3 bins, 5 bins, 7 bins, 9 bins, 11 bins, or 12 bins, or can be an amount falling within a range between any of the foregoing.

In various embodiments, the one or more bins 102 are configured to fit within the receptacle 104. The one or more bins 102 can be configured to fit into the receptacle 104 in one or more orientations. The one or more bins 102 can be configured to fit into the receptacle 104 such that at least one side of each bin is parallel with at least one side of the receptacle. The one or more bins 102 can fit into the receptacle such that they do not slip with respect to the bottom surface of the receptacle 104. The one or more bins 102 can be easily removed from and placed in the receptacle 104. The one more bins 102 can be rearrangeable within the receptacle 104 such that the one or more bins can be placed in the receptacle in multiple configurations. The one or more bins 102 scan pan substantially the entire area of the receptacle 104.

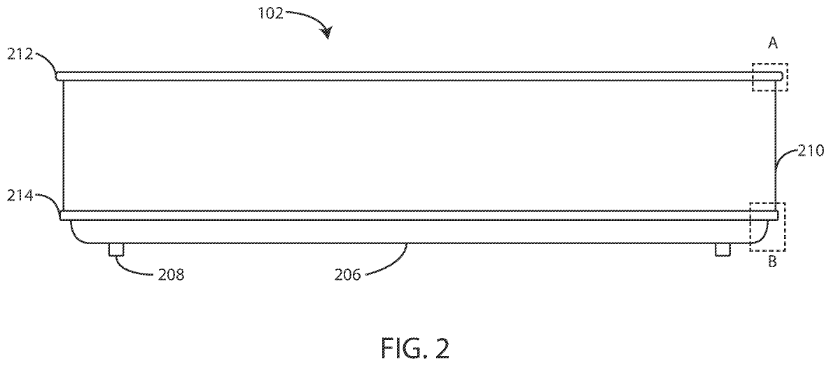

FIGS. 2-6 show a representative bin of the organization system in accordance with various embodiments herein. The features described for the representative bin can apply to each of the one or more bins of the organization system. Referring now to FIG. 2, a side view of a bin is shown in accordance with various embodiments herein. The bin 102 can have a bottom bin surface 206 and a bin wall 210 surrounding the bottom bin surface. In various embodiments, the bottom bin surface 206 is substantially flat. In various embodiments, the bottom bin surface 206 is perpendicular to the bin wall 210. In various embodiments, the bin can have one or more feet 208 protruding from a lower face of the bottom bin surface 206.

In various embodiments, the bin 102 can have an upper projection 212 protruding from the bin wall 210. In some embodiments the upper projection 212 can protrude outwards form the bin wall 210. In some embodiments the upper projection 212 can protrude inwards form the bin wall 210. In some embodiments the upper projection 212 can protrude both outwards and inwards form the bin wall 210. In some embodiments, the upper projection 212 is positioned at the top of the bin wall 210. In some embodiments, the upper projection 212 spans the entire perimeter of the bin wall 210. In some embodiments, the upper projection 212 spans at least part way across one set of parallel sides of the bin wall 210. In some embodiments, the upper projection 212 spans at least part way across two opposing sets of parallel sides of the bin wall 210.

In various embodiments, the bin can have a lower projection 214 protruding from the bin wall 210. In some embodiments the lower projection 214 can protrude outwards form the bin wall 210. In some embodiments the lower projection 214 can protrude inwards form the bin wall 210. In some embodiments the lower projection 214 can protrude both outwards and inwards form the bin wall 210. In some embodiments, the lower projection 214 spans the entire perimeter of the bin wall 210. In some embodiments, the upper projection 212 spans at least one set of parallel sides of the bin wall 210. In some embodiments, the upper projection 212 spans two opposing sets of parallel sides of the bin wall 210.

In various embodiments, the upper projection 212 and the lower projection 214 are substantially parallel. In various embodiments, the lower projection 214 is disposed beneath the upper projection 212 on the bin wall 210. In various embodiments, the lower projection 214 is disposed on the bin wall 210 such that it closer to the bottom bin surface 206 than to the top of the top of the bin wall 210. In some embodiments, the lower projection 214 can be disposed greater than or equal to 50%, 60%, 70%, 80%, 90%, or 100% of the way between the top of the bin and the bottom bin surface 206.

In some embodiments, the bin 102 maintains a constant cross-sectional shape from the bottom bin surface 206 to the top of the bin. In some embodiment the bin 102 maintains a constant cross-sectional shape between the lower projection 214 and the upper projection 212. In various embodiments, the cross-sectional shape of the bin 102 tapers from the lower projection 214 to the bottom bin surface 206.

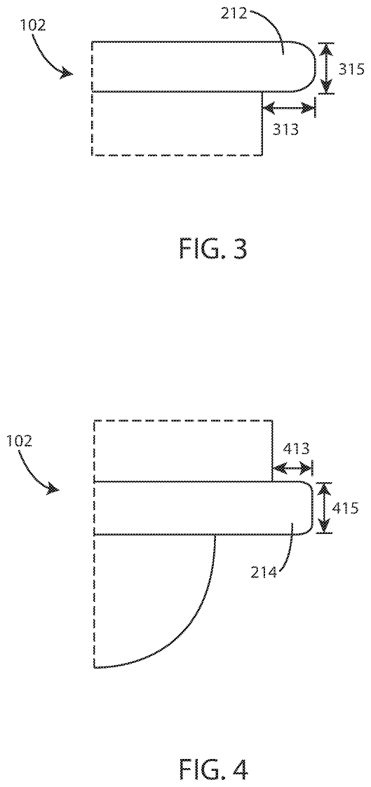

Referring now to FIG. 3, a detailed view of the bin of FIG. 2 depicting area A is shown in accordance with various embodiments herein. In various embodiments the top and bottom surfaces of the upper projection 212 are substantially flat. In various embodiments the top and bottom surfaces of the upper projection 212 are substantially parallel to one and other. In various embodiments, the outer edge of the upper projection 212 is parallel to the bin wall 210. In various embodiments, the outer edge of the upper projection 212 is rounded.

In various embodiments the upper projection 212 can protrude depth 313 from the bin wall 210. In some embodiments, the depth 313 can be greater than or equal to 0.25 mm, 1.25 mm, 2.25 mm, 3.25 mm, 4.25 mm, or 5.00 mm, or can be an amount falling within a range between any of the foregoing. In some embodiments, the depth 313 can be less than or equal to 5.00 mm, 4.00 mm, 3.00 mm, 2.00 mm, 1.00 mm, or 0.25 mm, or can be an amount falling within a range between any of the foregoing. In some embodiments, the depth can fall within a range of 0.25 mm to 5.00 mm, or 0.50 mm to 4.00 mm, or 0.60 mm to 3.00 mm, or 0.80 mm to 2.00 mm, or can be about 1 mm. In various embodiments, the upper projection 212 maintains the same depth 313 across the entire perimeter of the bin wall 210. In various embodiments the depth 313 varies across the perimeter of the bin wall 210.

In various embodiments the upper projection 212 can span width 315 across the bin wall 210. In some embodiments, the width 315 can be greater than or equal to 0.25 mm, 1.25 mm, 2.25 mm, 3.25 mm, 4.25 mm, or 5.00 mm, or can be an amount falling within a range between any of the foregoing. In some embodiments, the width 315 can be less than or equal to 5.00 mm, 4.00 mm, 3.00 mm, 2.00 mm, 1.00 mm, or 0.25 mm, or can be an amount falling within a range between any of the foregoing. In some embodiments, width 315 can fall within a range of 0.25 mm to 5.00 mm, or 0.40 mm to 4.00 mm, or 0.60 mm to 3.00 mm, or 0.80 mm to 2.00 mm, or can be about 1 mm. In various embodiments, the upper projection 212 maintains the same width 315 across the entire perimeter of the bin wall 210. In various embodiments the width 315 varies across the perimeter of the bin wall 210.

Referring now to FIG. 4, a detailed view of the bin of FIG. 2 highlighting area B is shown in accordance with various embodiments herein. In various embodiments the top and bottom surfaces of the lower projection 214 are substantially flat. In various embodiments the top and bottom surfaces of the lower projection 214 are substantially parallel to one and other. In various embodiments, the outer edge of the lower projection 214 is parallel to the bin wall 210. In various embodiments, the outer edge of the lower projection 214 is rounded.

In various embodiments the lower projection 214 can protrude depth 413 from the bin wall 210. In some embodiments, the depth 413 can be greater than or equal to 0.25 mm, 1.25 mm, 2.25 mm, 3.25 mm, 4.25 mm, or 5.00 mm, or can be an amount falling within a range between any of the foregoing. In some embodiments, the depth 413 can be less than or equal to 5.00 mm, 4.00 mm, 3.00 mm, 2.00 mm, 1.00 mm, or 0.25 mm, or can be an amount falling within a range between any of the foregoing. In some embodiments, the depth can fall within a range of 0.25 mm to 5.00 mm, or 0.40 mm to 4.00 mm, or 0.60 mm to 3.00 mm, or 0.80 mm to 2.00 mm, or can be about 1 mm. In various embodiments, the lower projection 214 maintains the same depth 413 across the entire perimeter of the bin wall 210. In various embodiments the depth 413 varies across the perimeter of the bin wall 210.

In various embodiments, the upper projection 212 and the lower projection 214 protrude substantially the same depth from the bin wall 210. In various embodiments, the upper projection 212 protrudes further from the bin wall 210 than the lower projection 214. In various embodiments, the lower projection 214 protrudes further from the bin wall 210 than the upper projection 212.

In various embodiments the lower projection 214 can span width 415 across the bin wall 210. In some embodiments, the width 415 can be greater than or equal to 0.25 mm, 1.25 mm, 2.25 mm, 3.25 mm, 4.25 mm, or 5.00 mm, or can be an amount falling within a range between any of the foregoing. In some embodiments, the width 415 can be less than or equal to 5.00 mm, 4.00 mm, 3.00 mm, 2.00 mm, 1.00 mm, or 0.25 mm, or can be an amount falling within a range between any of the foregoing. In some embodiments, the depth can fall within a range of 0.25 mm to 5.00 mm, or 0.40 mm to 4.00 mm, or 0.60 mm to 3.00 mm, or 0.80 mm to 2.00 mm, or can be about 1 mm. In various embodiments, the lower projection 214 maintains the same width 415 across the entire perimeter of the bin wall 210. In various embodiments the width 415 varies across the perimeter of the bin wall 210.

In various embodiments, the upper projection 212 and the lower projection 214 span the same width across the bin wall 210. In various embodiments, the upper projection 212 spans a wider width across the bin wall 210 than the lower projection 214. In various embodiments, the lower projection 214 spans a wider width across the bin wall 210 than the upper projection 212.

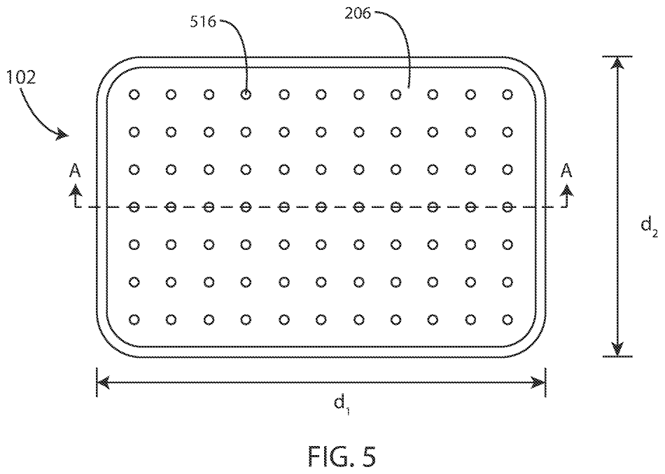

Referring now to FIG. 5, a top view of a bin is shown in accordance with various embodiments herein. The bin 102 can be of any shape that has at least one set of parallel sides. In various embodiments, the bin 102 has two opposing sets of parallel sides. In various embodiments, the bin 102 is substantially rectangular in area having two opposing sets of parallel sides. In various embodiments, the bin 102 can be rounded at the corners.

In various embodiments, the upper side of the bottom bin surface 206 is textured. The texture of the bottom bin surface 206 can be configured to prevent slippage of items placed in the bin across the bottom bin surface 206. In various embodiments, the bottom bin surface 206 can have a plurality of bumps 516. The plurality of bumps 516 can be substantially hemispherical in volume, but other geometries are imaginable.

In various embodiments, the bin 102 has a first bin dimension d₁ and a second bin dimension d₂. The first bin dimension d₁ spans the distance between the outer edge of the upper projection 212 on a first side of the bin and the outer edge of the upper projection on the opposite side of the bin. The second bin dimension d₂ spans the distance between the outer edge of the upper projection 212 on a second side of the bin and the outer edge of the upper projection on the opposite side of the bin. In various embodiments, the bin 102 can have two sets of opposing parallel sides. The first bin dimension d₁ can span the distance between the first set of parallel sides and the second bin dimension d₂ can span the distance between the second set of parallel sides. In various embodiments, the bin 102 is substantially rectangular and the first set of parallel sides are perpendicular to the second set of parallel sides.

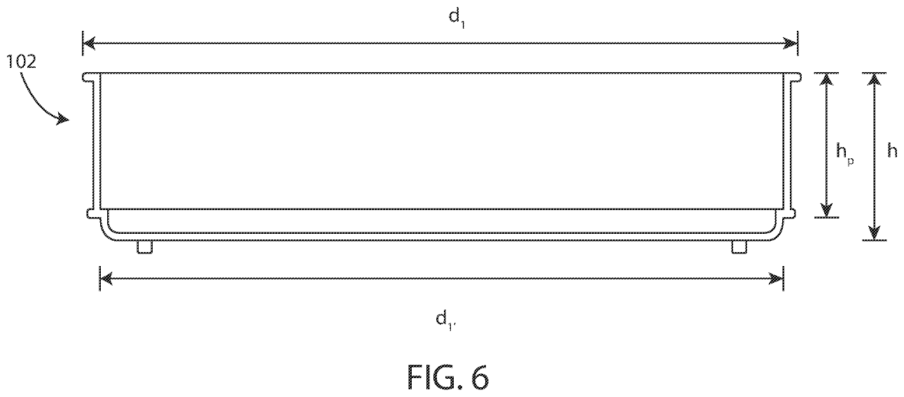

Referring now to FIG. 6, a cross sectional view of a bin taken along line A-A of FIG. 5 is shown in accordance with various embodiments herein. In various embodiments, the bin 102 has a first bin dimension d₁ and a first lower bin dimension d_{1′}. As previously described, the first bin dimension d₁ spans the distance between the outer edge of the upper projection 212 on a first side of the bin and the outer edge of the upper projection on the opposite side of the bin. The first lower bin dimension d_{1′} spans the distance between the outside of the bin 102 on a first side and the outside of a bin on a second side opposite to the first side just beneath the lower projection 214. In various embodiments, the first lower bin dimension d_{1′} is less than the first bin dimension d₁. Similarly, bin 102 can have a second dimension d₂ and a second lower bin dimension d_{2′} (not pictured in this view) with the second lower bin dimension being less than the second bin dimension.

In various embodiments, the bin has a bin height h. The bin height h spans the distance between the top of the bin 102 and the bottom bin surface 206. In various embodiments, the bin has a projection height hₚ. The projection height hₚ spans the distance between the top of the bin 102 and the lower projection 214. In some embodiments, the projection height hₚ can be greater than or equal to 50 percent, 60 percent, 70 percent, 80 percent, or 90 percent, or can be an amount falling within a range between any of the foregoing of the bin height h.

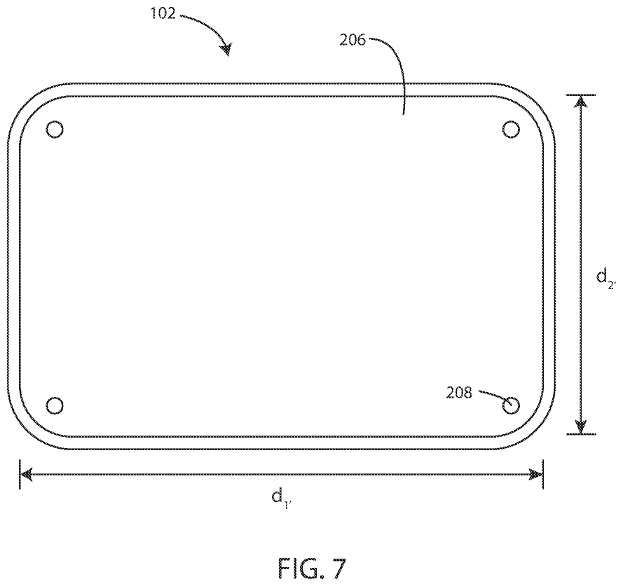

Referring now to FIG. 7, a bottom view of a bin is shown in accordance with various embodiments herein. In various embodiments, the bin 102 has a first lower bin dimension d_{1′} and a second lower bin dimension d_{2′}. The first lower bin dimension d_{1′} spans the distance between the outside of the bin on a first side and the outside of a bin on a second side opposite to the first side just beneath the lower projection 214. The second lower bin dimension d_{2′} spans the distance between the outside of the bin on a second side and the outside of a bin on a second side opposite to the first side just beneath the lower projection 214. In various embodiments, the bin can have two sets of opposing parallel sides. The first lower bin dimension d_{1′} can span the distance between the first set of parallel sides and the second lower bin dimension d_{2′} can span the distance between the second set of parallel sides. In various embodiments, the cross-sectional area of the bin tapers beneath the lower projection such that the first lower bin dimension d_{1′} is less than the first bin dimension d₁ and the second lower bin dimension d_{2′} is less than the second bin dimension d₂.

In various embodiments, bin 102 can have one or more feet 208 protruding from a lower face of the bottom bin surface 206. In various embodiments the one or more feet 208 are configured mate with openings disposed on the bottom of the receptacle 104. In various embodiments, the one or more feet can be circular in cross section, but other cross-sectional shapes are imaginable. In some embodiments, each bin 102 can have one or more openings in place of the one or more feet 208 on the bottom bin surface 206. In some embodiments, the one or more openings can be circular in cross section, but other cross-sectional shapes are imaginable. In some embodiments, the bottom bin surface 206 is devoid of feet or openings on the bottom bin surface 206.

A key feature of the present application is that one bin can be stacked on top and slid across another bin in multiple orientations. In various embodiments, a first bin can be stacked on top of a second bin in a first orientation if the first bin dimension of the first bin is equal to the first bin dimension or the second bin dimension of the second bin such that the lower projection of the first bin engages with the upper projection of the second bin and the first bin can slide along the upper projection of the second bin on a first set of parallel sides; and. In various embodiments, the first bin can be stacked on top of the second bin in a second orientation if the second bin dimension of the first bin is equal to the first bin dimension or the second bin dimension of the second bin such that the lower projection of the first bin engages with the upper projection of the second bin and the first bin can slide along the upper projection of the second bin on a second set of parallel sides.

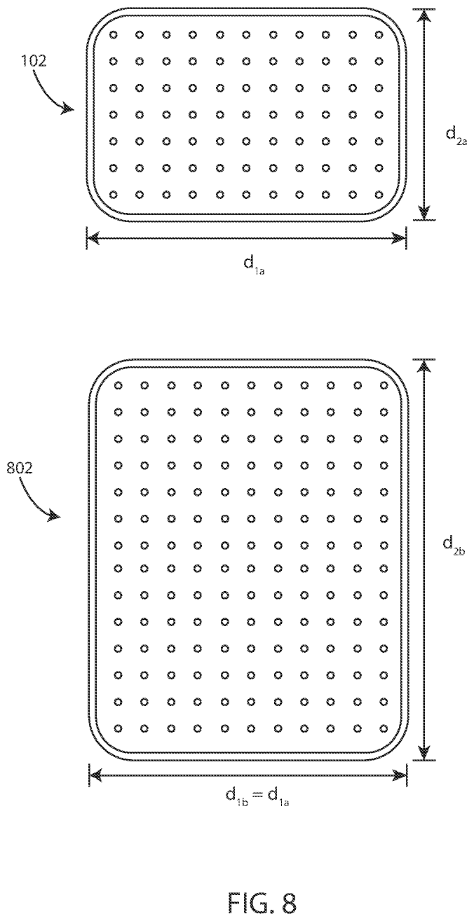

FIGS. 8-10 depict an example of how a first bin can be stacked and slid on top of another bin in multiple orientations. Referring now to FIG. 8, a top view of a pair of bins is shown in accordance with various embodiments herein. The pair of bins can include a first bin 102 and a second bin 802. The second bin 802 can have substantially similar features to the first bin 102 as previously described. The first bin 102 has a first dimension d₁ₐ and a second dimension d₂ₐ. The second bin 802 has a first dimension d_{1b} and a second dimension d_{2b}. In the example of FIG. 6, the first dimension of the first bin d₁ₐ is selected to be substantially equal to the first dimension of the second bin d_{1b} and the second dimension of the first bin d₂ₐ is selected to be less than the second dimension of the second bin d_{2b}.

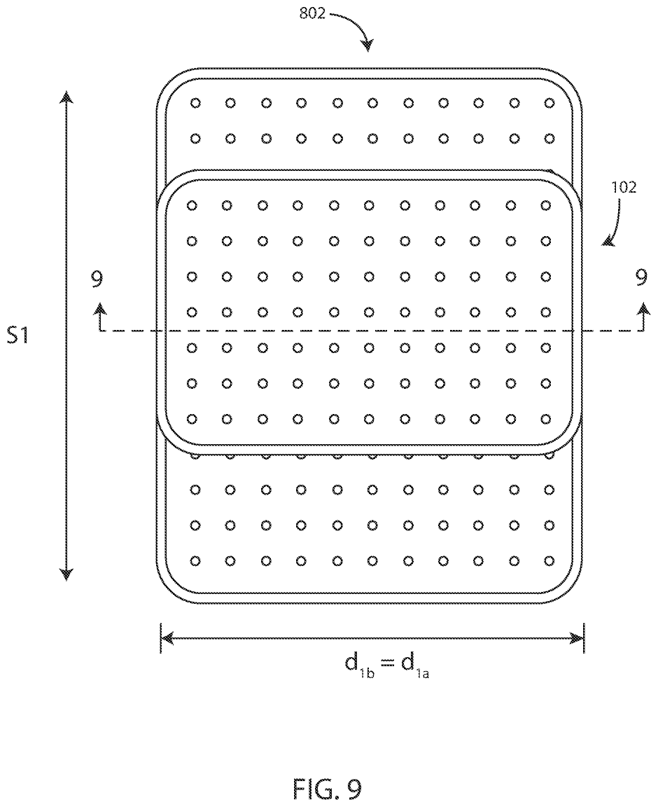

Referring now to FIG. 9, a top view the pair of bins of FIG. 8 in a stacked configuration is shown in accordance with various embodiments herein. As described above, the first dimension of the first bin d₁ₐ is selected to be substantially equal to the first dimension of the second bin d_{1b}. The first bin 102 can be aligned with the second bin 802 such that the first dimension of the first bin d₁ₐ is parallel to the first dimension of the second bin d_{1b}. The first bin 102 can then be stacked on top of the second bin 802 such that the lower projection of the first bin engages with the upper projection of the second bin and the first bin can slide in direction S1 along a first set of parallel sides with respect to the second bin.

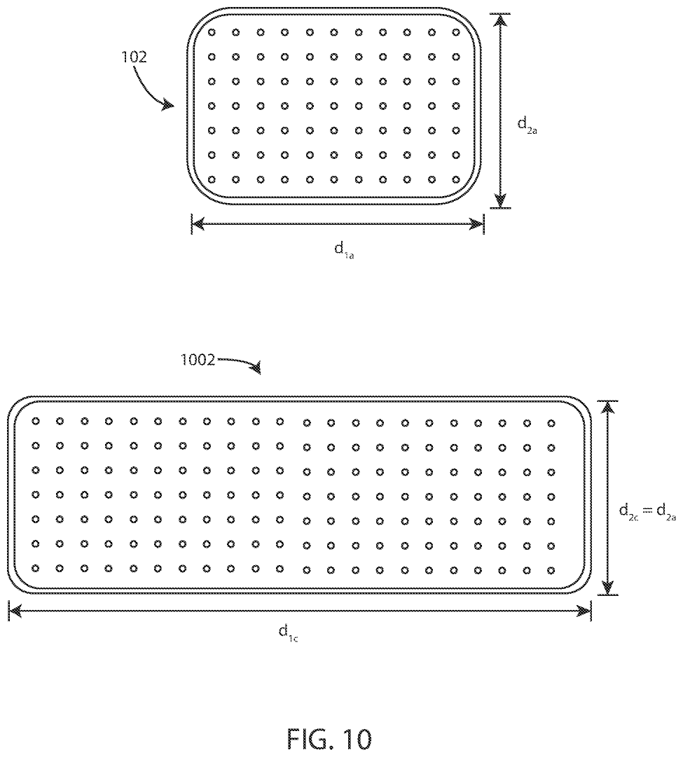

Referring now to FIG. 10, a top view of a pair of bins is shown in accordance with various embodiments herein. The pair of bins can include a first bin 102 and a third bin 1002. The third bin 1002 can have substantially similar features to the first bin 102 as previously described. The first bin 102 has a first dimension d₁ₐ and a second dimension d₂ₐ. The third bin 1002 has a first dimension d_{1c} and a second dimension d_{2c}. In the example of FIG. 8, the second dimension of the first bin d₂ₐ is selected to be substantially equal to the second dimension of the third bin d_{2c} and the first dimension of the first bin d₁ₐ is selected to be less than the first dimension of the third bin d_{1c}.

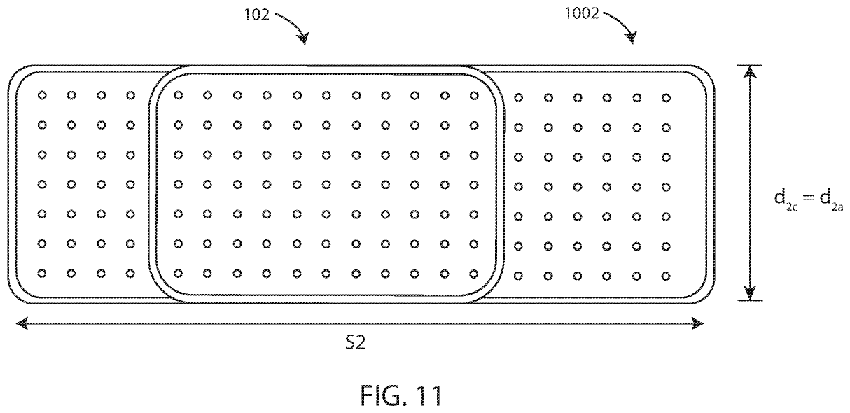

Referring now to FIG. 11, a top view the pair of bins of FIG. 10 in a stacked configuration is shown in accordance with various embodiments herein. As described above, the second dimension of the first bin d₂ₐ is selected to be substantially equal to the second dimension of the third bin d_{2c}. The first bin 102 can be aligned with the third bin 1002 such that the second dimension of the first bin d₂ₐ is parallel to the second dimension of the third bin d_{2c}. The first bin 102 can then be stacked on top of the third bin 1002 such that the lower projection of the first bin engages with the upper projection of the third bin and the first bin can slide in direction S2 along a second set of parallel sides with respect to the third bin.

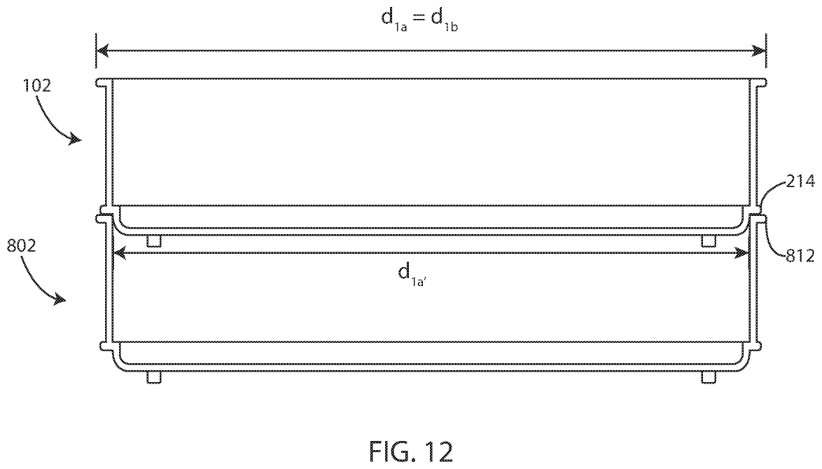

Referring now to FIG. 12, a cross-sectional view of a pair of bins taken along line 9-9 of FIG. 9 is shown in accordance with various embodiments herein. As depicted, the bottom side of the lower projection 214 of the first bin 102 engages with the top side of the upper projection 812 of the second bin 802. The lower projection 214 of the first bin 102 can slide along the upper projection 812 of the second bin 802 on a first set of parallel sides. In various embodiments, the bottom of surface of the lower projection 214 and top surface of the upper projection 812 are substantially smooth and parallel to one another. In various embodiments, the first bin can disengage from the second bin by lifting the first bin away from the second bin. In various embodiments, the first lower dimension of the first bin d_{1a′} is selected to smaller than the first bin dimension d₁ₐ such that at least a portion of the first bin 102 can slide in and out of the second bin 802 and the lower projection 214 of the first bin can be supported by the upper projection 812 of the second bin.

While the example of FIG. 12 shows the engagement between the first bin and the second bin, it can be exemplary of engagement between any two bins of compatible bin dimensions.

It should be noted that other stacking configurations are possible. Configurations are not limited to stacking one bin on top of another. Multiple bins can be stacked as long as a common bin dimension is shared. In various embodiments, multiple bins can be stacked on top of a single bin. In various embodiments, a third bin can be placed on a stack of a first and second bin, a fourth bin can be placed on top of a stack of a first, second, and third bin, and so on.

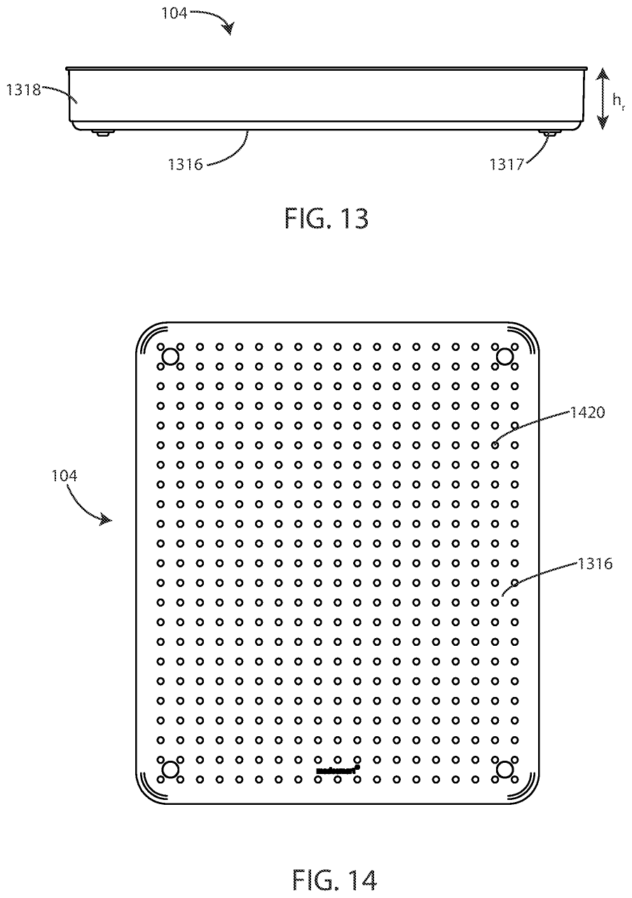

Referring now to FIG. 13, a side view of a receptacle is shown in accordance with various embodiments herein. The receptacle 104 can have a bottom receptacle surface 1316 and a receptacle wall 1318 surrounding the perimeter of the bottom receptacle surface. In various embodiments, the bottom receptacle surface 1316 is substantially flat. In various embodiments the receptacle 104 can be sized to fit one or more bins 102. The receptacle 104 can have receptacle height hᵣ spanning from the bottom receptacle surface 1316 to the top of the receptacle. In various embodiments, the receptacle height hᵣ is chosen such that the top of the receptacle 104 aligns with the tops of the one or more bins 102 when the bins are placed in the receptacle 104. In various embodiments, the receptacle height hᵣ is chosen to be substantially equal to the bin height h of each of the one or more bins 102.

Referring now to FIG. 14 a top view of a receptacle is shown in accordance with various embodiments herein. The receptacle 104 can be of any shape that accommodates the one or more bins. In various embodiments, the receptacle 104 can be substantially rectangular in area. In various embodiments, the receptacle 104 can be rounded at the corners.

In various embodiments, the bottom receptacle surface 1316 can have a plurality of receptacle openings 1420. In various embodiments, the plurality of receptacle openings 1420 are of a size and shape compatible to mate with the one or more feet 208 of each of the bins 102. The plurality of receptacle openings 1420 can be slightly larger in cross section than the one or more bin feet 208, such that there is clearance between the bin feet and the receptacle openings. The plurality of receptacle openings 1420 can be substantially circular in cross section, but other geometries are imaginable. plurality of receptacle openings 1420 can be spaced as to be compatible with the spacing of the of the bin feet 208 of each of the bins 102.

In various embodiments, the mating of the bin feet 208 with the plurality of receptacle openings 1420 prevents the bins 102 from sliding with respect to the bottom receptacle surface 1316. However, other means of preventing sliding of the bins are imaginable. In various embodiments, the bottom receptacle surface 1316 can have a plurality of protrusions and each of the bins 102 can have one or more holes. The one or more holes of each of the bins 102 can be configured to mate with the plurality of protrusions of the bottom receptacle surface 1316. In various embodiments, the bins 102 and receptacle 104 lack holes or protrusions. In various embodiments the bins 102 can be kept from slipping on the bottom receptacle surface 1316 by Velcro, magnets, or other means. Other means of preventing the bins 102 from slipping with respect to the bottom receptacle surface 1316 are imaginable.

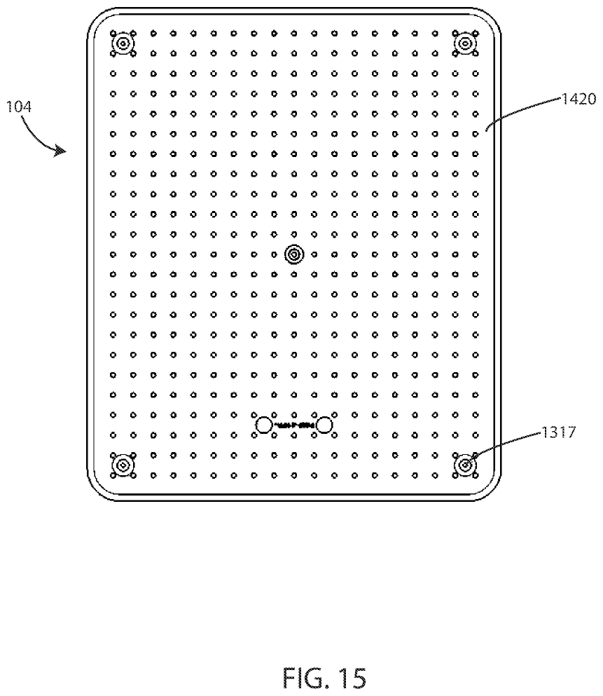

Referring now to FIG. 15, a bottom view of a receptacle is shown in accordance with various embodiments herein. In various embodiments, the receptacle 104 can have one or more receptacle feet 1317 protruding from a bottom face of the bottom receptacle surface 1316. In various embodiments, the receptacle 104 can have a receptacle foot 1317 at each corner of the bottom receptacle surface 1316. In various embodiments, the receptacle feet 1317 are configured to prevent the receptacle 104 from slipping with respect to the surface that it placed on. In various embodiments, the one or more receptacle feet 1317 are circular in cross section, but other cross-sectional shapes are possible.

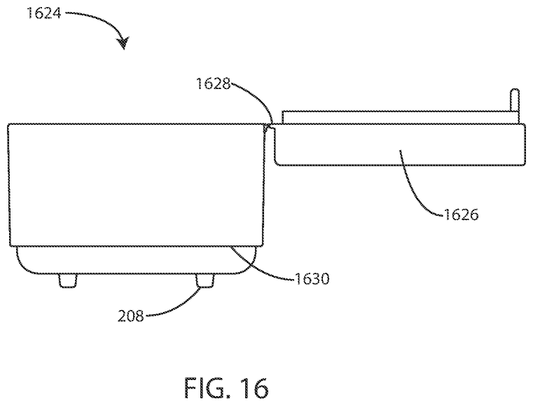

Referring now to FIG. 16, a side view of a lidded bin is shown accordance with various embodiments herein. The lidded bin 1624 can have a lid 1626. In some embodiments, the lid 1626 is affixed to the lidded bin 1624 by a hinge 1628. In various embodiments, the lidded bin can have one or more feet 208 configured to mate with one or more openings 1420 of the receptacle 104.

In various embodiments the lidded bin 1624 is sized to fit within the receptacle 104. The height of the lidded bin 1624 spanning from the bottom surface of the lidded bin to the top of the lid 1626, when the lid is closed, can be substantially the same as the bin height h and/or the receptacle height hᵣ. In various embodiments, the lidded bin 1624 can have a constriction in cross-sectional area forming a ridge 1630. In some embodiments, the ridge 1630 can be disposed greater than or equal to 50 percent, 60 percent, 70 percent, 80 percent, or 90 percent of the way down between the top of the lid 1626 and the bottom surface of the lidded bin 1624. In various embodiments the lidded bin 1624 can share a common bin dimension with at least one of the one or more bins 102 of an organization system 100. In various embodiments, the lidded bin 1624 can be stacked on top of a bin 102 with a common bin dimension and slid along the upper projection of the bin on ridge 1630.

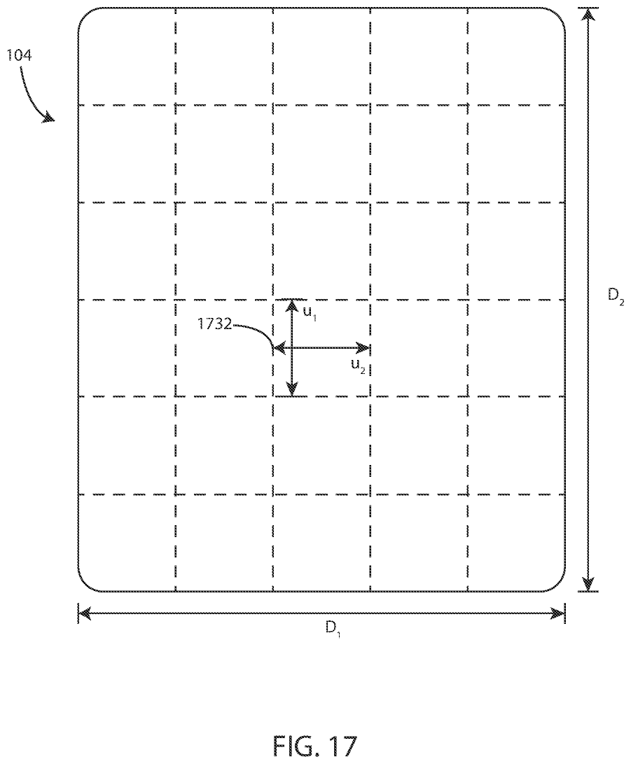

Referring now to FIG. 17, a schematic top view of a receptacle 104 is shown accordance with various embodiments herein. In various embodiments, the receptacle 104 can have two sets of opposing parallel sides. The first receptacle dimension D₁ can span the distance between the first set of parallel sides and the second receptacle dimension D₂ can span the distance between the second set of parallel sides. In various embodiments, the receptacle 104 is substantially rectangular in area and the first set of parallel sides are perpendicular to the second set of parallel sides.

In various embodiments, the cross-sectional area of the receptacle can span a discrete number of bin units 1732. A bin unit 1732 is defined as a unit of area with unit length u₁ and unit width u₂. In various embodiments, the receptacle 104 is rounded at the corners cutting into the bin units 1732 at each of the corners. In various embodiments the first receptacle dimension D₁ and the second receptacle dimension D₂ are a discrete number of bin units 1732 in length. The first receptacle dimension D₁ can span a lesser number, equal number, or greater number of bin units than the second receptacle dimension D₂.

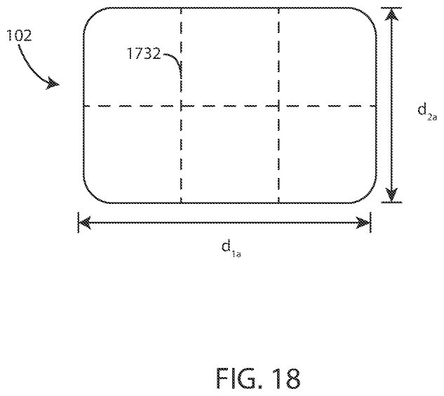

Referring now to FIG. 18, a schematic top view of a bin 102 is shown accordance with various embodiments herein. As previously described, the bin 102 can have first and second bin dimensions, d₁ₐ and d₂ₐ. In various embodiments, the cross-sectional area of the bin 102 can span a discrete number of bin units 1732. In various embodiments, the bin 102 is rounded at the corners cutting into the bin units 1732 at each of the corners. In various embodiments the first bin dimension d₁ₐ and the second bin dimension d_{1b} are a discrete number of bin units 1732 in length. The first bin dimension d₁ₐ can span a lesser number, equal number, or greater number of bin units than the second bin dimension d_{1b}.

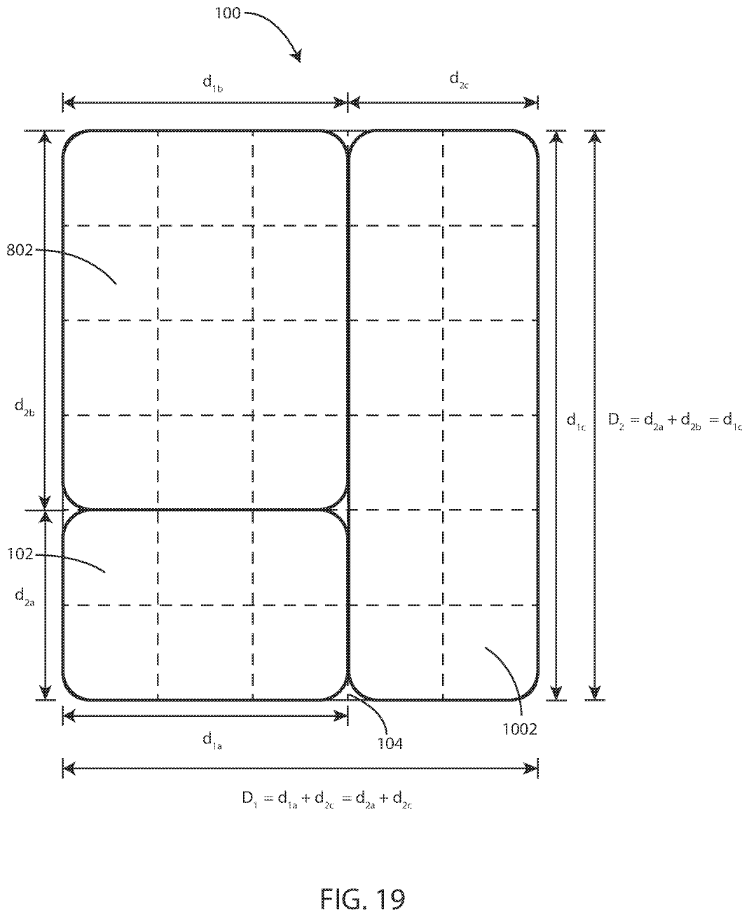

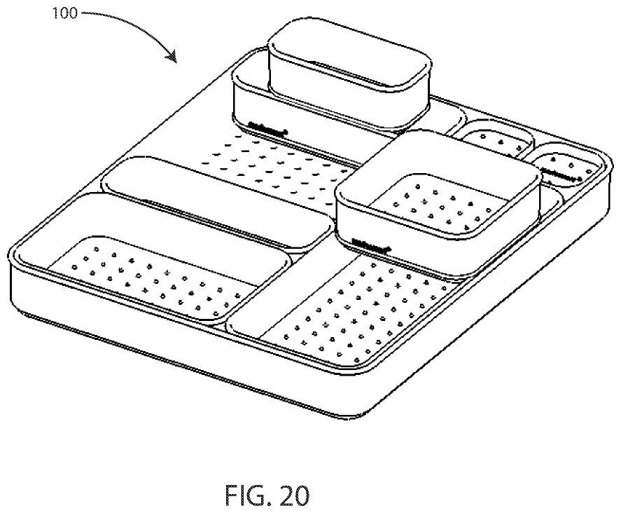

Referring now to FIG. 19, a schematic top view of an organization system is shown accordance with various embodiments herein. FIG. 19 depicts an exemplary organization system having a receptacle 104, and three bins 102, 802, and 1002. The concepts explained in this exemplary embodiment can apply to any number of organization systems, including organization systems with different receptacle and bin geometries and different numbers of bins.

In various embodiments, the combined number of bin units for all of the bins 102, 802, 1002 is equal to the number of bin units of the receptacle 104. In various embodiments, when placed in the receptacle 104, the bins 102, 802, and 1002 span substantially the entire area of the bottom receptacle surface 1316.

In some embodiments, the receptacle 104 and bins 102, 802, 1002 can have similar curvature at the corners. In some embodiments, the corners of the bins 102, 802, 1002 can be substantially flush with the corners of the receptacle 104. In some embodiments, a gap can exist between the corners of the bins 102, 802, 1002 and the corners of the receptacle 104. In some embodiments, gaps can exist between the corners of the bins 102, 802, 1002 meeting with one and other within the receptacle 104.

In some embodiments, the at least one side of bins 102, 802, 1002 can be substantially flush with the receptacle wall 1318. In some embodiments, there can be a gap between the bins 102, 802, 1002 and the receptacle wall 1318. In some embodiments the sides of the bins 102, 802, 1002 can be substantially flush with one and other when placed in the receptacle 104. In some embodiments, gaps can exist between the sides of the bins 102, 802, 1002 meeting with one another within the receptacle. In various embodiments, the bins 102, 802, 1002 can be placed in the receptacle 104 in various configurations. For instance, the positions of the bins 102 and 802 can be swapped in the receptacle 104.

The organization systems of FIGS. 1 and 19 depict organization systems where all of the bins have been placed on the bottom receptacle surface such that the bins span the entire area of the receptacle. In these embodiments, the bins can be placed in the receptacle in multiple configurations such that the bins span the entire area of the of the bottom receptacle surface. However, additional configurations are possible.

Referring now to FIG. 20, a perspective view of an organization system is shown accordance with various embodiments herein. FIG. 20 shows the organization system 100 of FIG. 1 with the bins 102 in a different configuration. In various embodiments, some, but not all of the bins 102 can be positioned within the receptacle 104 on the bottom receptacle surface 1316. In various embodiments, the one or more bins do not span the entire area of the bottom receptacle surface 1316.

In various embodiments, one or more of the bins 102 can be stacked on top bins of compatible bin dimensions that are positioned in the receptacle 104. In various embodiments a first bin can be placed in the receptacle such that the bin feet 208 of the first bin engage with the openings 1420 of the bottom receptacle surface 1316. A second bin of compatible bin dimensions can be stacked on top of the first bin and slid with respect to the first bin without the first bin slipping with respect to the bottom receptacle surface 1316.

In various embodiments, a bin can be removed from the bottom receptacle surface 1316 and placed on top of a bin with compatible bin dimensions. In various embodiments, a bin can be removed from the top of another bin and placed within the receptacle on the bottom receptacle surface. In various embodiments, not all of the bins are placed in the organization system. In various embodiments, one or more of the bins of an organization system can be used to store items externally to the organization system

singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An organization system comprising:
a receptacle;
one or more bins configured to fit within the receptacle, each bin having a first bin dimension and a second bin dimension, each bin comprising:
a bottom bin surface;
a bin wall surrounding the perimeter of the bottom bin surface;
an upper projection protruding from the bin wall; and
a lower projection protruding from the bin wall beneath the upper projection;
wherein a first bin can be stacked on top of a second bin in a first orientation if the first bin dimension of the first bin is equal to the first bin dimension or the second bin dimension of the second bin such that the lower projection of the first bin engages with the upper projection of the second bin and the first bin can slide along the upper projection of the second bin on a first set of parallel sides; and
wherein the first bin can be stacked on top of the second bin in a second orientation if the second bin dimension of the first bin is equal to the first bin dimension or the second bin dimension of the second bin such that the lower projection of the first bin engages with the upper projection of the second bin and the first bin can slide along the upper projection of the second bin on a second set of parallel sides.

2. The organization system of claim 1, the receptacle having a first receptacle dimension and a second receptacle dimension, wherein the first receptacle dimension and the second receptacle dimension are a discrete number of bin units in length.

3. The organization system of claim 2, wherein the first bin dimension and the second bin dimension of each bin are a discrete number of bin units in length.

4. The organization system of claim 3, wherein the combined number of bin units for all of the one or more bins is equal to the number of bin units of the receptacle.

5. The organization system of claim 4, wherein all of the one or more bins can be placed in the receptacle such that the one or more bins span substantially the entire area of the bottom receptacle surface.

6. The organization system of claim 5, wherein the one or more bins can be placed in the receptacle in multiple configurations.

7. The organization system of claim 3, wherein the combined length of one or more of the bins is equal to the number of bin units of the first receptacle dimension and/or the second receptacle dimension.

8. The organization system of claim 1, wherein the upper projection spans the entire perimeter of the bin wall.

9. The organization system of claim 1, wherein the lower projection spans the entire perimeter of the bin wall.

10. The organization system of claim 1, wherein the upper projection and the lower projection both protrude between 0.5 mm and 2 mm from the bin wall.

11. The organization system of claim 1, wherein the lower projection is be disposed greater than or equal to 50%, of the way down between the top of the bin and the bottom bin surface.

12. The organization system of claim 1, wherein the lower projection protrudes no further from the bin wall than the upper projection.

13. The organization system of claim 1, wherein each of the bins comprises a means for preventing slipping with respect to the bottom receptacle surface.

14. The organization system of claim 1, wherein each of the one or more bins comprises a plurality of feet to engage with a plurality of opening in the bottom receptacle surface.

15. The organization system of claim 1, wherein the receptacle and each of the bins have anti-microbial properties.

16. The organization system of claim 1, wherein the cross-sectional area of each of the one or more bins tapers beneath the lower projection.

17. A bin system comprising:
A first bin having a first bin dimension and a second bin dimension, the first bin comprising:
a first bottom surface;
a first wall surrounding the perimeter of the first bottom bin surface, the first wall comprising:
an first upper projection protruding from the first bin wall; and
a first lower projection protruding from the first bin wall beneath the first upper projection;
A second bin having a first bin dimension and a second bin dimension, the second bin comprising:
a second bottom surface;
a second wall surrounding the perimeter of the second bottom bin surface, the second wall comprising:
a second upper rim protruding outward from of the second wall; and
a second lower rim protruding outward from the second wall beneath the second upper rim,
wherein the first bin can be stacked on top of the second bin in a first orientation if the first bin dimension of the first bin is equal to the first bin dimension or the second bin dimension of the second bin such that the first lower projection engages with the second upper projection and the first bin can slide along the second upper projection on a first set of parallel sides; and
wherein the first bin can be stacked on top of the second bin in a second orientation if the second bin dimension of the first bin is equal to the first bin dimension or the second bin dimension of the second bin such that the first lower projection engages with the second upper projection and the first bin can slide along the second upper projection on a second set of parallel sides.

18. The bin system of claim 17 further comprising:
A third bin having a first bin dimension and a second bin dimension, the first bin comprising:
a third bottom surface;
a third wall surrounding the perimeter of the third bottom bin surface, the third wall comprising:
and third upper projection protruding from the first bin wall; and
a third lower projection protruding from the first bin wall beneath the first upper projection;
wherein the third bin can be stacked on top of the first bin or the second bin in a first orientation if the first bin dimension of the third bin is equal to the first bin dimension or the second bin dimension of the first bin or the second bin such that the third lower projection engages with the first upper projection or the second upper projection and the third bin can slide along the first upper projection or the second upper projection on a first set of parallel sides; and
wherein the third bin can be stacked on top of the first bin or the second bin in a second orientation if the second bin dimension of the third bin is equal to the first bin dimension or the second bin dimension of the first bin or the second bin such that the third lower projection engages with the first upper projection or the second upper projection and the third bin can slide along the first upper projection or the second upper projection on a second set of parallel sides.

19. An organization system comprising:
a receptacle having a first receptacle dimension and a second receptacle dimension, wherein the first receptacle dimension and the second receptacle dimension are a discrete number of bin units in length
one or more bins configured to fit within the receptacle, each bin having a first bin dimension and a second bin dimension, wherein the first bin dimension and the second bin dimension of each bin are a discrete number of bin units in length, each bin comprising:
a bottom bin surface;
a bin wall surrounding the perimeter of the bottom bin surface;
an upper projection protruding from the bin wall; and
a lower projection protruding from the bin wall beneath the upper projection;
wherein a first bin can be stacked on top of a second bin in a first orientation if the first bin dimension of the first bin is equal to the first bin dimension or the second bin dimension of the second bin such that the lower projection of the first bin engages with the upper projection of the second bin and the first bin can slide along the upper projection of the second bin on a first set of parallel sides; and
wherein the first bin can be stacked on top of the second bin in a second orientation if the second bin dimension of the first bin is equal to the first bin dimension or the second bin dimension of the second bin such that the lower projection of the first bin engages with the upper projection of the second bin and the first bin can slide along the upper projection of the second bin on a second set of parallel sides. wherein the combined number of bin units for all of the one or more bins is equal to the number of bin units of the receptacle such that the one or more bins can be placed in the receptacle such that the one or more bins span substantially the entire area of the bottom receptacle surface.

20. The organization system of claim 19, wherein the one or more bins can be placed in the receptacle in multiple configurations.
